(19) United States
(12) Patent Application Publication
(10) Pub. No.: US 2007/0009799 A1
(43) Pub. Date: Jan. 11, 2007

(54) Electrochemical cell having a partially oxidized conductor

(75) Inventor: Guanghong Zheng, Avon, OH (US)

Correspondence Address: MICHAEL C. POPHAL;EVEREADY BATTERY COMPANY INC, 25225 DETROIT ROAD, P O BOX 450777, WESTLAKE, OH, 44145, US

(73) Assignee: Eveready Battery Company, Inc.

(21) Appl. No.: 11/176,416

(22) Filed: Jul. 7, 2005

(51) Int. Cl. H01M 4/58; C01B 31/00

(52) U.S. Cl. 429/231.8; 29/623.1; 423/415.1

(57) ABSTRACT

An electrochemical cell having an aqueous electrolyte and an electrode with partially oxidized graphite mixed with an electrochemically active material is disclosed. The graphite is oxidized on its surface and within a specified range to improve the aqueous electrolyte's ability to diffuse into the electrode. The weight ratio of active material to graphite is maximized to improve performance on high drains tests.

### BACKGROUND OF THE INVENTION

This invention generally relates to electrochemical cells having an electrode with electrochemically active material mixed with graphite. More particularly, this invention is concerned with a cathode for a hermetically sealed alkaline electrochemical cell having partially oxidized graphite as the conductor.

Cylindrically shaped electrochemical cells are suitable for use by consumers in a wide variety of devices such as flashlights, radios and cameras. Batteries used in these devices typically employ a cylindrical metal container to house two electrodes, a separator, a quantity of electrolyte and a closure assembly that includes a current collector. Typical electrode materials include manganese dioxide as the cathode and zinc as the anode. An aqueous solution of potassium hydroxide is a common electrolyte. A separator, conventionally formed from one or more strips of paper, is positioned between the electrodes. The electrolyte is readily absorbed by the separator, anode and cathode.

Due to the ever present desire to provide consumers with improved products, battery engineers are constantly striving to increase the length of time that a battery will power a consumer's device while also maintaining or reducing the cost of the battery. One key objective is to improve the service of the battery when it is used to power a high drain device such as a digital camera. In order to achieve this objective, processes for reducing the cathode's total polarization were investigated. As is recognized in the art, commercially available cylindrical alkaline batteries use a cathode that includes a mixture of manganese dioxide and an electrically conductive material such as powdered graphite. The graphite provides an electrically conductive matrix throughout the cathode while the manganese dioxide functions as the cathode's electrochemically active material. The weight ratio of manganese dioxide to graphite must be controlled within certain parameters to facilitate simultaneously achieving the following objectives. First, maximizing the cell's run time in various battery powered devices with diverse electrical requirements, such as a digital still camera which requires a “high rate” discharge, as well as a wall mounted clock that requires a “low rate” of discharge. According to conventional wisdom, one way to improve the run time of the battery during a high rate discharge is to reduce the ratio of manganese dioxide to graphite thereby increasing the quantity of graphite relative to the quantity of manganese dioxide. Conversely, to improve the run time of the battery on a low rate discharge, the ratio of manganese dioxide to graphite would typically be increased thereby increasing the quantity of manganese dioxide to graphite. Second, because the cost of premium graphite is typically higher than the cost of manganese dioxide, the quantity of graphite should be minimized in order to minimize the cost of the cell. As the quantity of graphite is increased, the cell's cost increases which is undesirable. Furthermore, as the quantity of graphite increases the cathode's polarization increases because the graphite, which is inherently hydrophobic, slows the diffusion of the aqueous electrolyte throughout the cathode. Efficient distribution of electrolyte throughout the cathode is needed to discharge the cell in a device that requires a high drain discharge. Clearly, the need to maximize the cell's run time must be balanced against cost constraints when selecting the weight ratio of manganese dioxide to graphite to use in the cell.

Therefore, there exists a need for an alkaline electrochemical cell that facilitates superior performance on a high drain test by increasing the quantity of graphite without increasing the cathode's polarization.

### BRIEF SUMMARY OF THE INVENTION

The present invention provides an electrochemical cell that incorporates manganese dioxide, graphite, zinc, an alkaline electrolyte and is capable of providing improved service when discharged at a high rate.

In one embodiment, an electrochemical cell of the present invention includes a hermetically sealed container housing a first electrode, a second electrode, a separator disposed between the first and second electrodes and an aqueous electrolyte in contact with the electrodes and the separator. The first electrode includes a mixture of an electrochemically active material and graphite. The graphite, prior to mixing with the active material, has a surface oxidation of 1.5 to 6.0 mAh/g based on the weight of the graphite.

The present invention also relates to a process, for assembling a hermetically sealed electrochemical cell, including the steps of: providing a quantity of particulate graphite; partially oxidizing the surface of the graphite to obtain a surface oxidation between 1.5 and 6.0 mAh/g; mixing the partially oxidized graphite with an electrochemically active material to form an electrochemically active mixture; and assembling the mixture into a container comprising a second electrode, a separator disposed between the first and second electrodes, an electrolyte contacting the electrodes and separator, and a seal assembly.

### BRIEF DESCRIPTION OF THE DRAWINGS

FIG. 1 is a cross-section of an electrochemical cell of the present invention;

FIG. 2 is a chart showing the surface oxidation values of various graphites;

FIG. 3 shows the service results of AA size batteries that included a first commercially available graphite;

FIG. 4 shows the service results of AA size batteries that included a second commercially available graphite; and

FIG. 5 is a chart of process steps.

### DETAILED DESCRIPTION OF THE INVENTION

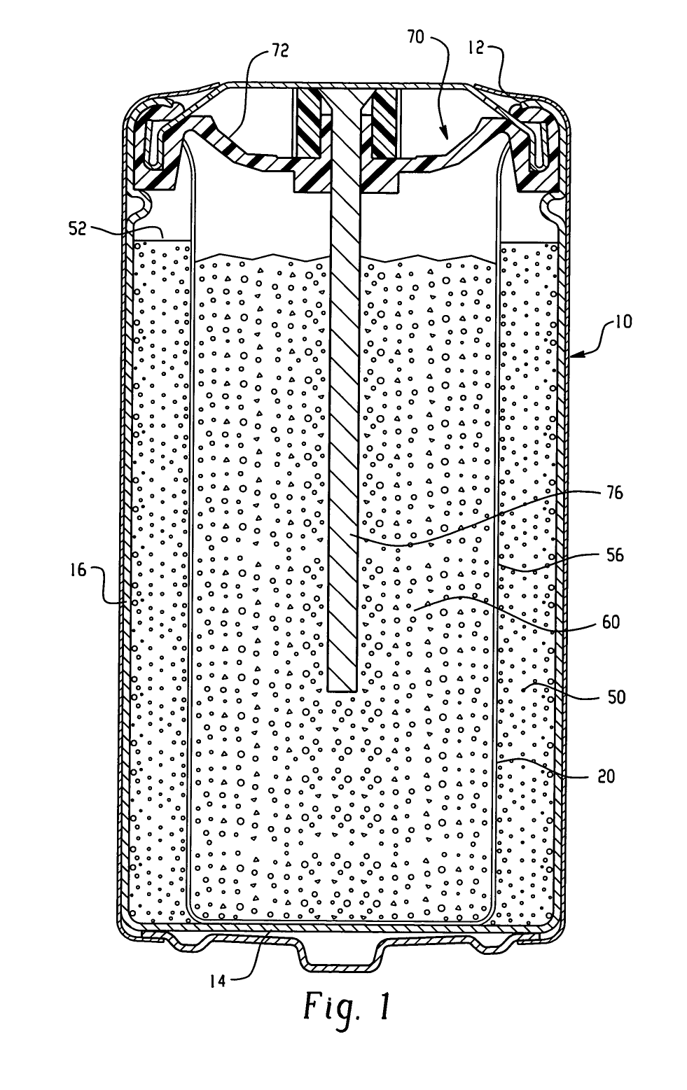

Referring now to the drawings and more particularly to FIG. 1, there is shown a cross-sectional view of an assembled electrochemical cell of this invention. Beginning with the exterior of the cell, the cell's components are the container 10, first electrode 50 positioned adjacent the interior surface of container 10, separator 20 contacting the interior surface 56 of first electrode 50, second electrode 60 disposed within the cavity defined by separator 20 and closure assembly 70 secured to container 10. Container 10 has an open end 12, a closed end 14 and a sidewall 16 therebetween. The closed end 14, sidewall 16 and closure assembly 70 define a cavity in which the cell's electrodes are housed.

First electrode 50 is a mixture of manganese dioxide, oxidized graphite and an aqueous solution containing potassium hydroxide. The electrode is formed by disposing a quantity of the mixture into the open ended container and then using a ram to mold the mixture into a solid tubular shape that defines a cavity which is concentric with the sidewall of the container. First electrode 50 has a ledge 52 and an interior surface 56. Alternatively, the cathode may be formed by preforming a plurality of rings from the mixture comprising manganese dioxide and oxidized graphite and then inserting the rings into the container to form the tubularly shaped first electrode. Alternate electrochemically active materials include: nickel oxyhydroxide, silver oxide and copper oxide.

Second electrode 60 is a homogenous mixture of an aqueous alkaline electrolyte, zinc powder, and a gelling agent such as crosslinked polyacrylic acid. The aqueous alkaline electrolyte comprises an alkaline metal hydroxide such as potassium hydroxide, sodium hydroxide, or mixtures thereof. Potassium hydroxide is preferred. The gelling agent suitable for use in a cell of this invention can be a crosslinked polyacrylic acid, such as Carbopol 940®, which is available from Noveon, Cleveland, Ohio, USA. Carboxymethyylcellulose, polyacrylamide and sodium polyacrylate are examples of other gelling agents that are suitable for use in an alkaline electrolyte solution. The zinc powder may be pure zinc or an alloy comprising zinc and an appropriate amount of one or more of the metals selected from the group consisting of indium, lead, bismuth, lithium, calcium and aluminum. A suitable anode mixture contains 67.0 weight percent zinc powder, 0.5 weight percent gelling agent and 32.5 weight percent alkaline electrolyte having 40 weight percent potassium hydroxide. The quantity of zinc can range from 63 percent by weight to 70 percent by weight of the anode. Other components such as gassing inhibitors, organic or inorganic anticorrosive agents, binders or surfactants may be optionally added to the ingredients listed above. Examples of gassing inhibitors or anticorrosive agents can include indium salts (such as indium hydroxide), perfluoroalkyl ammonium salts, alkali metal sulfides, etc. Examples of surfactants can include polyethylene oxide, polyethylene alkylethers, perfluoroalkyl compounds, and the like. The second electrode may be manufactured by combining the ingredients described above into a ribbon blender or drum mixer and then working the mixture into a wet slurry.

Electrolyte suitable for use in a cell of this invention is a thirty-seven percent by weight aqueous solution of potassium hydroxide. The electrolyte may be incorporated into the cell by disposing a quantity of the fluid electrolyte into the cavity defined by the first electrode. The electrolyte may also be introduced into the cell by allowing the gelling medium to absorb an aqueous solution of potassium hydroxide during the process used to manufacture the second electrode. The method used to incorporate electrolyte into the cell is not critical provided the electrolyte is in contact with the first electrode 50, second electrode 60 and separator 20.

Closure assembly 70 comprises closure member 72 and current collector 76. Closure member 72 is molded to contain a vent that will allow the closure member 72 to rupture if the cell's internal pressure becomes excessive. Closure member 72 may be made from Nylon 6,6 or another material, such as a metal, provided the current collector 76 is electrically insulated from the container 10 which serves as the current collector for the first electrode. Current collector 76 is an elongated nail shaped component made of brass. Collector 76 is inserted through a centrally located hole in closure member 72.

Separator 20 is made from nonwoven fibers. One of the separator's functions is to provide a barrier at the interface of the first and second electrodes. The barrier must be electrically insulating and ionically permeable. A suitable separator is disclosed in WO 03/043103.

Conventional cylindrical alkaline electrochemical cells include a first electrode, which may be referred to herein as a cathode, which is a mixture of at least manganese dioxide and graphite. Depending upon the cell's design intent, the weight ratio of manganese dioxide to graphite can be varied between 5:1 and 30:1. If the ratio exceeds 30:1, then the quantity of graphite is insufficient to form a conductive matrix throughout the cathode for the life of the cell. If the ratio is less than 5:1, then the quantity of graphite negatively impacts the cell's run time because too much of the electrochemically active manganese dioxide has been replaced by graphite which is not electrochemically active.

The type of graphite used in alkaline cells may be natural graphite or synthetic graphite. Natural graphite is mined from the ground and is generally used without modification except to remove undesirable impurities. Commercially available sources of natural graphite for use in alkaline cells include Nippon Graphite Industries, Ltd. (Japan), Chuetsu Graphite Works Co., Ltd. (Japan) and Nacional de Grafite Ltda. (Brazil). In contrast, synthetic graphite is produced in a manufacturing facility where generally petroleum coke and coal-tar pitch are heated about 1000° C. in a nonoxiding atmosphere to remove volatiles, then the resultant carbon is transformed to graphite by heat treatment at 3000° C. Thermal decomposition of carbonaceous gases is also used to produce synthetic graphite. Synthetic graphites may be purchased from Timcal America, Westlake, Ohio, USA. Furthermore, graphites may be expanded or nonexpanded. If a graphite is expanded, it is first dried at about 80° C. for a sufficient period of time, then the dried graphite is mixed with sulfuric acid (intercalant) and nitric acid (oxidizer) for about 24 hours. Finally, the intercalated graphite is heated rapidly to 900° C. or higher for a few seconds to cause the structure of the graphite particle to expand along a central axis thereby increasing the length of the graphite. Expanded graphite may be purchased from Superior Graphite Co., Chicago, Ill., USA, SGL Technic Inc., Valencia, Calif., USA, Nippon Graphite Industries, Ltd. (Japan), and Chuetsu Graphite Works Co., Ltd. (Japan). Nonexpanded graphite is not treated to cause the particles to expand.

One of the fundamental physical characteristics of graphite is its hydrophobic nature which causes the graphite to naturally repel water or an aqueous based solution, such as an aqueous alkaline electrolyte, away from the surface of the graphite particle. Because of its hydrophobic nature, as the weight percent of graphite in an electrode is increased, the electrode's polarization also increases because the graphite slows the diffusion of electrolyte into the cathode (or first electrode). Rapid penetration of electrolyte into the electrode is necessary to enable the cell to discharge in an efficient manner. An increase in the electrode's polarization reduces the cell's run time. To counteract the increase in cathode polarization, a cell designer could specify a reduction in the quantity of graphite used in the first electrode. Unfortunately, as the quantity of graphite is reduced, the electrical conductivity of the first electrode also decreases. As the conductivity decreases, the cell's internal resistance increases which reduces the cell's run time. This phenomenon is particularly noticeable on high drain service tests such as a test that emulates performance in a digital still camera.

In order to resolve the dilemma of how to increase the quantity of graphite in the first electrode in order to increase the cathode's conductivity without simultaneously increasing the cathode's polarization, the inventor of the invention described herein has discovered that graphite which has been partially oxidized on its surface within certain limits, which may be referred to herein as partially oxidized graphite, can be used in place of all or part of the non-oxidized graphite typically found in the cathode in order to increase the quantity of graphite without increasing the cathode's polarization. The graphite must be oxidized on its surface a sufficient amount to reduce the hydrophobic nature of the graphite without significantly decreasing the graphite's conductivity.

Although various ways of oxidizing the surface of graphite are known, a preferred method is to mix the powdered graphite with an aqueous solution of sulfuric acid and sodium nitrate for at least one hour. In one sample preparation, the following procedure was used. First, 500 ml of H₂SO₄ was disposed into a clean 1000 ml beaker. One gram of NaNO₃ was weighed out. The NaNO₃ was sprinkled into the sulfuric acid to minimize clumping and then stirred by a stir plate for approximately five minutes. Twenty grams of graphite was then added to the solution as it was stirred. The time that the graphite was added to the solution was recorded and is considered the start of the oxidation process. The graphite was exposed to the NaNO₃/H₂SO₄ solution for one hour. The entire contents of the beaker was then poured into a 500 ml Buchner funnel that had been lined with glassfiber filter paper identified as Whatman Binder-Free Glass Microfiber Filters Type GF/F. No water was used during the filtration process. The beaker and utensils were then rinsed with water which was collected in a two liter beaker. When the filtration was complete, the graphite patty was carefully removed from the filter paper and placed into the beaker with the rinse water. Water was added to minimize the exothermic reaction between the water and H₂SO₄. Stirring was used to break the patty into smaller lumps. The filter paper was rinsed into the two liter beaker. The entire solution was returned to the stir plate where it was stirred for a minimum of 10 minutes. The stirred solution was filtered once again using the Buschner funnel and the GF/F filter paper. Again the graphite patty was removed from the paper and added to 2000 ml of water where the patty was broken up by stirring. Ten cubic centimeters of a 45 weight percent KOH solution was then added to neutralize the solution. The solution was stirred for another ten minutes. Three additional cycles of the filter and wash process, including the use of additional KOK, were completed. A total of five filter papers were used. After the fifth cycle, the patty was removed from the filter paper and placed on a watch glass and then stored overnight in a 60° C. oven. The dried patty was then broken up using a mortar and pestle and a bench top blender. The material was stored in an airtight container. The pH of the graphite should be essentially neutral. If needed the graphite can be rewashed in water, filtered and dried again until the desired pH is obtained.

The objective of treating the graphite with sulfuric acid and sodium nitrate is to achieve a surface oxidation that will reduce the hydrophobic nature of the graphite, thereby avoiding an increase in the cathode's polarization, without negatively impacting the conductivity of the graphite. After the graphite has been acid treated as described above, the surface oxidation was determined using the following procedure. A 0.2 g quantity of the acid treated graphite was formed into a pellet measuring 0.425 inch diameter, 0.05 inch height and having about 30% porosity. The pellet was then discharged in a flooded half-cell at 1 mA/g rate in 40 wt percent KOH to 0.4V versus a zinc reference electrode. The surface oxidation of the graphite is defined as the discharged capacity of the graphite.

The surface oxidized graphite used in a cell of this invention must be oxidized above a minimum threshold necessary to reduce the graphite's hydrophobic nature and below a maximum threshold which would decrease the conductivity of the graphite such that the cell's service performance would be reduced. The following surface oxidation values are determined prior to mixing the partially oxidized graphite with the electrochemically active material. For expanded graphite, the optimum surface oxidation is 4.2 mAh/g. A suitable range of surface oxidation for expanded graphite is 4.0 mAh/g to 6.0 mAh/g. A more suitable range is 4.1 mAh/g to 4.4 mAh/g. For synthetic graphite, the optimum surface oxidation is 3.6 mAh/g. A suitable range is between 3.3 mAh/g to 3.9 mAh/g. A more suitable range is between 3.4 mAh/g to 3.8 mAh/g. Depending upon the type of graphite oxidized, the range of surface oxidation can vary between 3.3 mAh/g and 6.0 mAh/g. A more preferred range is between 3.4 mAh/g and 4.4 mAh/g. Graphites with lower surface oxidation values, such as 1.5, 2.0 and 3.0 mAh/g, are believed to be viable in certain cell constructions. If the graphite is oxidized such that the graphite flakes are substantially oxidized, which is characteristic of graphite commonly referred to as oxidized graphite, the graphite is not suitable for use in a cell of this invention because it lacks sufficient conductivity to establish a conductive network throughout an electrode when it is mixed with an electrochemically active material. Graphite that has a surface oxidation above 6.0 mAh/g is above the preferred range of surface oxidation suitable for use in this invention.

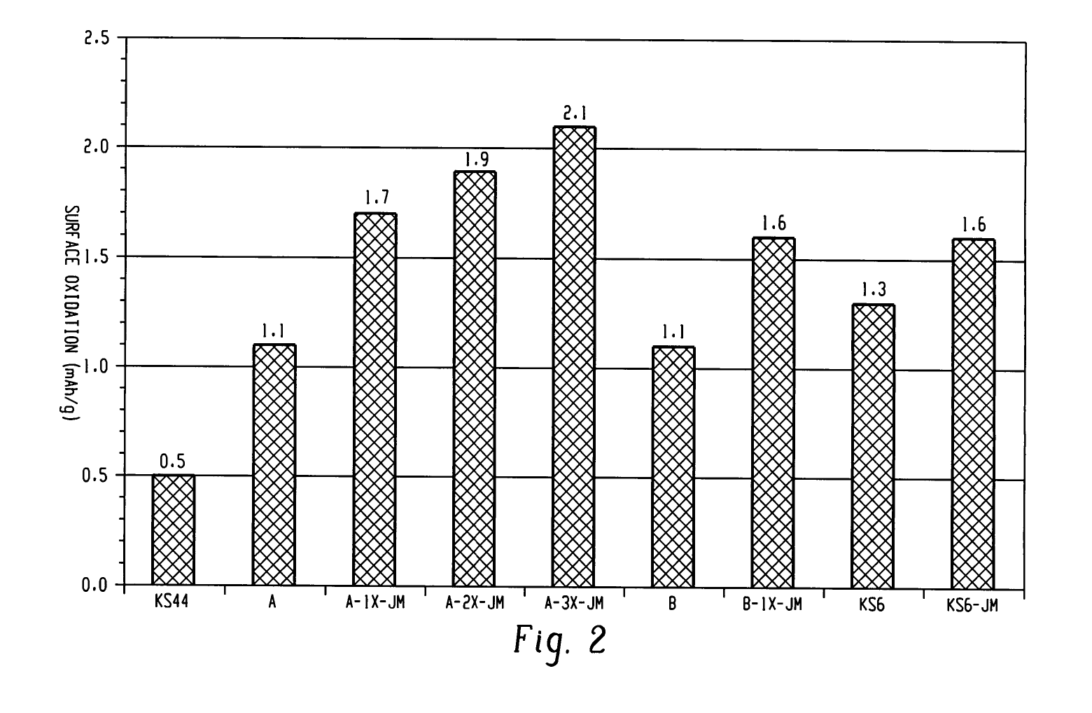

Shown in FIG. 2 is a bar chart that compares the surface oxidation of various samples of commercially available graphite samples. In the chart's horizontal legend, “JM” is an abbreviation for “jet milled”. The designations 1×, 2× and 3× identify graphites that have been jet milled one, two or three times, respectively. The sample designated KS44, which is a commercially available graphite that had not been treated to increase its surface oxidation, had a surface oxidation of 0.5 mAh/g. Two other commercially available samples, designated “A” and “B”, had surface oxidation values of approximately 1.1 mAh/g. When the B sample was processed through a Sturtevant 4-inch jet mill in order to decrease the size of the graphite flakes, the surface oxidation of the B graphite increased to approximately 1.6 mAh/g. This was achieved by grinding the graphite using a 50 g/hr feed rate at a line pressure of 90 PSI and volume of 60 cfm. Similarly, when the A sample of graphite was processed one time through the jet mill (designated A-1×-JM), the surface oxidation increased from 1.1 mAh/g to 1.7 mAh/g. When the same graphite was processed a second time (designated A-2×-JM) and then a third time (designated A-3×-JM, the surface oxidation increased to 1.9 mAh/g and 2.1 mAh/g, respectively. Clearly, the surface oxidation values of graphite can be increased by processing the graphite particles through a jet mill that causes the graphite particles to be reduced in size. While processing the particles through a jet mill is not a preferred way to increase a graphite's surface oxidation, the use of a jet mill is an acceptable process. By altering the parameters of the process, such as the length of time the graphite is exposed to the jet mill's spinning blades and the speed at which the blades are turning, the graphite's surface oxidation can be altered.

Graphite that has been surface oxidized as described above is most useful in cells that have a weight ratio of manganese dioxide to graphite less than 20:1. If the ratio of manganese dioxide to graphite exceeds 20:1 the increase in the electrode's internal resistance, caused by the lack of graphite, cannot be overcome by the decrease in electrode polarization due to the surface oxidation of the graphite and the graphite does not significantly impact the cathode's polarization. A more preferred range of manganese dioxide to graphite is less than 18:1.

If desired, some of the advantage of using partially oxidized graphite mixed with electrochemically active material can be obtained by combining a first portion of the graphite, which has been partially oxidized, with a second portion of graphite, that has not been oxidized, rather than using only partially oxidized graphite. By combining partially oxidized graphite with non-oxidized graphite, the potassium hydroxide diffusion coefficient of the electrode can be adjusted to a desired value. While a high potassium hydroxide diffusion coefficient is generally preferred to facilitate maximum run times on a high drain test, electrodes having a lower diffusion coefficient may be acceptable for cells that are designated for use in devices where superior performance on high drain tests is not critical. The quantity of partially oxidized graphite should be at least twenty percent of the total weight of the graphite, which includes both partially oxidized and non-oxidized graphite, in the electrode. More preferably, the quantity of oxidized graphite should be at least forty percent of the total weight of the graphite, both partially oxidized and non-oxidized, in the electrode.

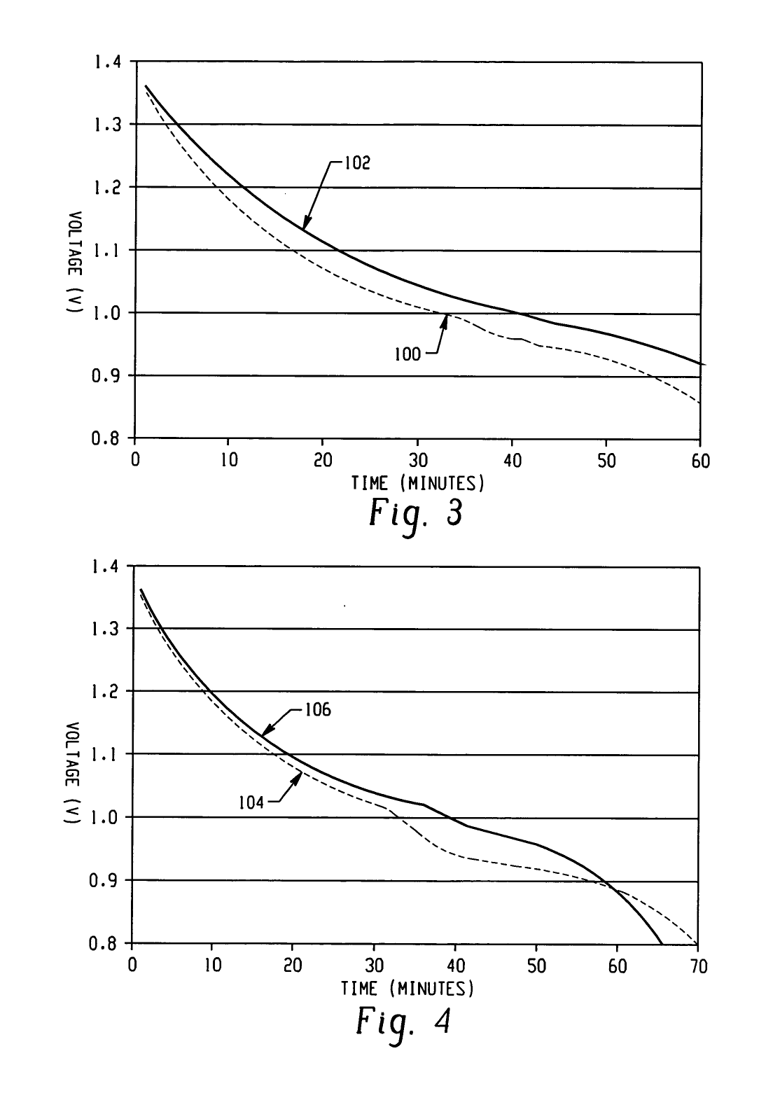

To demonstrate the advantage of the present invention, several LR6 size cells, which are approximately 50.5 mm long and 14.5 mm in diameter, were made with surface oxidized graphite mixed with the manganese dioxide in the cathode. The O/C ratio was 11.4:1. The cathode's dry ring porosity was 28%. The anode included 70 weight percent Zn and 29 weight percent gelled electrolyte. A commercially available graphite designated MX25, having an initial surface oxidation value of 0.5 mAh/g, was treated to increase the surface oxidation to 5.7 mAh/g. Another commercially available graphite, designated KS-44 and having an initial surface oxidation of 0.5 mAh/g, was treated to increase the surface oxidation to 5.2 mAh/g. Shown in FIG. 3 is a plot of closed circuit voltage versus time for cells that were made with the MX25 graphite. To evaluate the cells' run time, each cell was discharged at a 1000 mA rate for sixty seconds and then allowed to rest for five seconds. At the end of the five second rest period the cell was again discharged at a 1000 mA rate for sixty seconds and then allowed to rest for five seconds. The discharge regime was repeated until the cell's closed circuit voltage fell below 0.9 volts. The discharge curve of cells made with one-hundred percent “as received” MX25 graphite that had a 0.5 mAh/g surface oxidation is represented by curve 100. The discharge curve made by cells that included only the graphite that had been treated to increase the surface oxidation to 5.7 mAh/g is represented by curve 102. At the 1.0 V cutoff, which is the effective end point for many high drain devices, the cells of this invention provided approximately twenty one percent more run time than did the cells that did not utilize the surface oxidized graphite. Shown in FIG. 4 is another plot of closed circuit voltage versus time for cells made solely with graphite identified as KS-44. Each cell was discharged on the discharge test described above. Discharge curve 104 represents the cells that contained only the graphite that was used “as received” and therefore was not treated to increase the surface oxidation. Discharge curve 106 represents the cells that contained only the graphite that had been treated to increase the surface oxidation to 5.2 mAh/g. At the 1.0 volt cutoff, the cells of the present invention provided approximately eighteen percent more run time than did the cells using the non-treated graphite. Clearly, the cells of the present invention provided greater run time on a high rate discharge test regime than did the cells that were otherwise constructed identically except for the partial oxidation of the graphite.

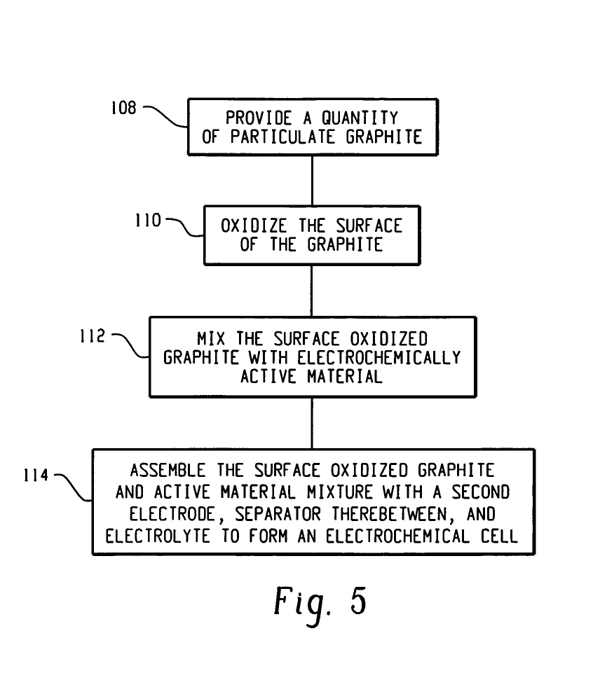

The following process can be used to manufacture cells of the present invention. Referring now to FIG. 5, step 108 represents providing a quantity of particulate graphite. The graphite may be natural or synthetic, expanded or nonexpanded. Preferably, the graphite should form a free flowing powder. In step 110, the surface of the graphite is oxidized to reduce the hydrophobic nature of the graphite. Preferably, the graphite has a surface oxidation between 1.5 mAh/g and 6.0 mAh/g. In step 112, the surface oxidized graphite is mixed with an electrochemically active material, such as manganese dioxide, thereby producing a mixture. The mixture of surface oxidized graphite and electrochemically active material is then assembled with a second electrode, a separator therebetween, electrolyte and a seal assembly to form an electrochemical cell. While the optimum value of the surface oxidation may vary depending upon the type of graphite, the percentage of potassium hydroxide in the electrolyte and the desired run time from the battery, the graphite is partially oxidized to the extent necessary to improve the ability of an aqueous potassium hydroxide electrolyte to diffuse into the mixture of the surface oxidized graphite and electrochemically active material that are included in the cell's first electrode. If the electrochemically active material is manganese dioxide, then the weight ratio of manganese dioxide to surface oxidized graphite is between 10:1 and 20:1.

The above description is considered that of the preferred embodiments only. Modifications of the invention will occur to those skilled in the art and to those who make or use the invention. Therefore, it is understood that the embodiments shown in the drawings and described above are merely for illustrative purposes and are not intended to limit the scope of the invention, which is defined by the following claims as interpreted according to the principles of patent law, including the Doctrine of Equivalents.

What is claimed is:

1. A hermetically sealed electrochemical cell, comprising: a container housing a first electrode, a second electrode, a separator disposed between said first and second electrodes, and an aqueous electrolyte in contact with said electrodes and separator, wherein said first electrode comprises a mixture of an electrochemically active material and graphite, said graphite, prior to mixing with said active material, having a surface oxidation of 1.5 to 6.0 mAhr/g based on the weight of said graphite.

2. The electrochemical cell of claim 1 wherein said graphite has a surface oxidation of 2.0 to 6.0 mAhr/g.

3. The electrochemical cell of claim 1, wherein said graphite has a surface oxidation of 3.4 to 4.5 mAhr/g.

4. The electrochemical cell of claim 1 wherein graphite is nonexpanded graphite.

5. The electrochemical cell of claim 4 wherein said nonexpanded graphite is natural graphite.

6. The electrochemical cell of claim 4 wherein said nonexpanded graphite is synthetic graphite.

7. The electrochemical cell of claim 6 wherein said graphite is expanded graphite.

8. The electrochemical cell of claim 7 wherein said expanded graphite is natural graphite.

9. The electrochemical cell of claim 7 wherein said expanded graphite is synthetic graphite.

10. The electrochemical cell of claim 1 wherein graphite comprises a first portion and a second portion, said first portion having a surface oxidation between 1.5 mAhr/g and 6.0 mAhr/g and said second portion having a surface oxidation less than 1.5 mAhr/g.

11. The electrochemical cell of claim 1 wherein electrochemically active material comprises manganese dioxide.

12. The electrochemical cell of claim 11 wherein said electrochemically active material further comprises at least one compound selected from the group consisting of nickel oxyhydroxide, silver oxide and copper oxide.

13. The electrochemical cell of claim 1 wherein the weight ratio of electrochemically active material to graphite in said first electrode is between 10:1 and 20:1.

14. The electrochemical cell of claim 13 wherein weight ratio is between 10:1 and 15:1.

15. A process for assembling an electrochemical cell comprising the steps of:
(a) providing a quantity of particulate graphite;
(b) partially oxidizing the surface of the graphite wherein the surface oxidation is between 1.5 and 6.0 mAh/g;
(c) mixing the oxidized graphite with an electrochemically active material to form an electrically conductive mixture; and
(d) assembling the mixture into a container comprising a second electrode, a separator disposed between said first electrode, a separator disposed between said first and second electrodes, an electrolyte and a seal assembly.

16. The process of claim 15 wherein said electrochemically active material is manganese dioxide and the weight ratio of manganese dioxide to partially oxidized graphite is between 10:1 and 20:1.

17. The process of claim 16 wherein said ratio is between 10:1 and 15:1.

18. The process of claim 15 wherein prior to step (b), said quantity of graphite is divided into at least a first portion and a second portion and, in step (b), only the first potion of graphite is partially oxidized thereby providing a partially oxidized first portion and a non-oxidized second portion, and, in step (c), mixing the first portion of partially oxidized graphite with the second non-oxidized portion and said electrochemically active material to form said mixture.

19. The process of claim 18, wherein said first portion of graphite has a partial oxidation between 1.5 mAhr/g and 6.0 mAhr/g and said second portion of graphite has a surface oxidation less than 1.5 mAhr/g.

20. The process of claim 18, wherein said first portion of graphite is at least twenty percent by weight of the total weight of graphite.

21. The process of claim 18, wherein said first portion of graphite is at least forty percent by weight of the total weight of graphite.
